(19) United States
(12) Patent Application Publication
(10) Pub. No.: US 2025/0335998 A1
(43) Pub. Date: Oct. 30, 2025

(54) SYSTEM AND METHOD FOR VALIDATING LLM REPORT CONTENT IN REGULATED FINANCIAL ENVIRONMENTS

(71) Applicant: VESTI.AI LTD., HAMPSHIRE (GB)

(72) Inventors: JONTY HURWITZ, HAMPSHIRE (GB); DEBORAH YANG, PARIS (FR); JEFFREY GINSBERG, MIDDLESEX (GB)

(21) Appl. No.: 19/192,389

(22) Filed: Apr. 29, 2025

Related U.S. Application Data
(60) Provisional application No. 63/640,226, filed on Apr. 30, 2024.

(51) Int. Cl. G06Q 40/06

(52) U.S. Cl. CPC G06Q 40/06

(57) ABSTRACT

A method, system, and non-transitory computer-readable medium are disclosed for validating financial report content generated through a retrieval-augmented generation (RAG) process utilizing large language models (LLMs). Source financial metrics are retrieved and provided to a first LLM for generating financial report content. A second LLM extracts financial metrics from the report content and compares them to the source financial metrics to detect hallucinated financial metrics. The second LLM may also evaluate the report content for financial advice or compliance violations.

### BACKGROUND

A large language model (LLM) is a type of artificial intelligence (AI) program trained on huge sets of data that may allow them to understand and generate human-like language with a high degree of fluency and coherence. LLMs may be based on neural network architectures, such as transformer-based models like GPT (Generative Pre-trained Transformer). In response to queries provided, an LLM may be susceptible to giving false information as part of a response. Such inaccurate statements within the response may be referred to as “hallucinations”.

### SUMMARY

Consistent with disclosed embodiments, a method, system, and non-transitory computer-readable medium are provided for ensuring compliance of financial report content generated through a retrieval-augmented generation (RAG) process utilizing large language models (LLMs). The method includes retrieving source financial metrics, providing the source financial metrics to a first LLM for generating financial report content, extracting, by a second LLM, extracted financial metrics from the financial report content, and comparing, by the second LLM, the extracted financial metrics to the source financial metrics to determine whether hallucinated financial metrics have been introduced. In some examples, prompts are engineered to enhance the first LLM's and second LLM's understanding of their respective tasks. The source financial metrics may include raw financial data, financial sentiment extracted from news articles, and/or analytical financial data. Hallucinations may involve incorrect contextual use, inclusion of unauthorized metrics, or corruption of existing data. Further, the second LLM may be prompted to evaluate the report content for financial advice or breaches of financial compliance rules. Communications with the LLMs may utilize application programming interfaces (APIs). The disclosed embodiments provide an effective technical solution for validating generative AI outputs against regulated financial data requirements.

Consistent with disclosed embodiments a non-transitory computer readable medium may contain instructions that when executed by at least one processor, cause the at least one processor to perform operations for ensuring compliance of financial report content generated by a first LLM as part of in a retrieval-augmented generation (RAG) process, the operations including: retrieving source financial metrics; providing the source financial metrics to a first large language model (LLM) for generating the financial report content therewith; extracting by a second LLM of extracted financial metrics from the report content and comparing by the second LLM the extracted financial metrics to the source financial metrics retrieved in the RAG process to determine whether the first LLM has introduced hallucinated financial metrics into the report content.

In some embodiments, the operations further include querying the first LLM with a report package including the source financial metrics and prompts engineered for understanding by the first LLM to generate the report content. In some embodiments, the operations further include querying the second LLM with the source financial metrics and the report content. In some embodiments, the query to the second LLM further includes prompts engineered for understanding by the second LLM to compare the source financial metrics and the report content.

In some embodiments, the source financial metrics include at least one of raw financial data, financial sentiment extracted from news articles, and/or analytical financial data. In some embodiments, the queries to the first and second LLMs make use of respective APIs provided by the first and second LLMs. In some embodiments, the hallucinated financial metrics include one of: use of the source financial metrics in an incorrect context, inclusion of metrics not provided in the source financial metrics, or corruption of metrics included in the source financial metrics.

In some embodiments, the operations further include, prompting the second LLM to evaluate whether the report content includes financial advice. In some embodiments, the operations further include, prompting the second LLM to evaluate whether the report content breaches financial compliance rules.

Consistent with disclosed embodiments a method for ensuring compliance of financial report content in a RAG process may include: retrieving source financial metrics; providing the source financial metrics to a first large language model (LLM) for generating the financial report content therewith; extracting by a second LLM of extracted financial metrics from the report content; and comparing by the second LLM the extracted financial metrics to the source financial metrics to determine whether the first LLM has introduced hallucinated financial metrics into the report content.

In some embodiments, the method further includes querying the first LLM with a report package including the source financial metrics and prompts engineered for understanding by the first LLM to generate the report content. In some embodiments, the method further includes querying the second LLM with the source financial metrics and the report content.

In some embodiments, the query to the second LLM further includes prompts engineered for understanding by the second LLM to compare the source financial metrics and the report content. In some embodiments, the source financial metrics include at least one of raw financial data, financial sentiment extracted from news articles, and/or analytical financial data. In some embodiments, the queries to the first and second LLMs make use of respective APIs provided by the first and second LLMs. In some embodiments, the hallucinated financial metrics include one of: use of the source financial metrics in an incorrect context, inclusion of metrics not provided in the source financial metrics, or corruption of metrics included in the source financial metrics.

In some embodiments, the method further includes, prompting the second LLM to evaluate whether the report content includes financial advice. In some embodiments, the method further includes, prompting the second LLM to evaluate whether the report content breaches financial compliance rules.

Consistent with disclosed embodiments, a system may include at least one processor configured to perform operations including: retrieving source financial metrics as part of a RAG process; providing the source financial metrics to a first large language model (LLM) for generating the financial report content therewith; extracting by a second LLM of extracted financial metrics from the report content; and comparing by the second LLM the extracted financial metrics to the source financial metrics to determine whether the first LLM has introduced hallucinated financial metrics into the report content.

In some embodiments, the operations further include querying the first LLM with a report package including the source financial metrics and prompts engineered for understanding by the first LLM to generate the report content. In some embodiments, the operations further include querying the second LLM with the source financial metrics and the report content.

In some embodiments, the query to the second LLM further includes prompts engineered for understanding by the second LLM to compare the source financial metrics and the report content. In some embodiments, the source financial metrics include at least one of raw financial data, financial sentiment extracted from news articles, and/or analytical financial data. In some embodiments, the queries to the first and second LLMs make use of respective APIs provided by the first and second LLMs. In some embodiments, the hallucinated financial metrics include one of: use of the source financial metrics in an incorrect context, inclusion of metrics not provided in the source financial metrics, or corruption of metrics included in the source financial metrics.

In some embodiments, the operations further include, prompting the second LLM to evaluate whether the report content includes financial advice. In some embodiments, the operations further include, prompting the second LLM to evaluate whether the report content breaches financial compliance rules.

This Summary is provided to introduce a selection of concepts in a simplified form that are further described in the Detailed Description below. It may be understood that this Summary is not intended to identify key features or essential features of the invention, nor is it intended to be used to limit the scope of the invention. The details of one or more implementations are set forth in the accompanying drawings and the description below. Other features will be apparent from the description and drawings.

### BRIEF DESCRIPTION OF THE DRAWINGS

The accompanying drawings, which are incorporated in and constitute a part of this specification, illustrate several embodiments of the invention and, together with the description, serve to explain the disclosed principles. In the drawings:

FIG. 1 is a block diagram of an exemplary computing device according to some implementations;

FIG. 2 shows a system for validating report content generated using an LLM according to some implementations; and

FIG. 3 is a diagram of an example process for validating LLM report content according to some implementations.

### DETAILED DESCRIPTION

Source data such as news or financial market data may be input to an LLM, along with relevant queries, to produce content related to the source data such as reports. In a Retrieval-Augmented Generation (RAG) process, relevant information or context such as financial metrics may be retrieved from a large corpus of documents or knowledge sources and be provided to an LLM to generate a response or output based on the retrieved information and an input query or prompt. As used herein, the terms ‘query’ and ‘prompt’ may be used interchangeably to refer to information provided to a large language model (LLM), including data and instructions, for the purpose of eliciting a generated output. Unless otherwise specified, references to a ‘query’ or ‘prompt’ are intended to encompass any form of structured or unstructured input to the LLM.

Particularly when RAG is used for financial data (referred to herein as “financial metrics”), it may be essential to confirm that the provided financial metrics have not been corrupted (“hallucinated”) by the LLM when providing a response or report, as such hallucinations may lead to non-compliance with financial regulations.

This disclosure presents systems and methods for performing validation procedures on generative AI content to test for accuracy and compliance. The invention described herein checks LLM report content generated from source data to ensure it is accurate by analyzing the LLM generated report content compared with the source data provided to the LLM as a query.

In some embodiments, an LLM may be used by a report generating service. For example, the report generating (reporting) service may provide source data to the LLM as a query and prompt the LLM to formulate the provided source data into report content that can then be formatted by the reporting service. The report content from the LLM may be analyzed by the disclosed system to determine whether the LLM has introduced hallucinations into the report content, such as but not limited to corrupted data, data used in the wrong context, or data in the report content not based on the provided source data. In some embodiments, a second LLM may be used to perform the comparative analysis.

Reference will now be made in detail to non-limiting examples of LLM validation implementations which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

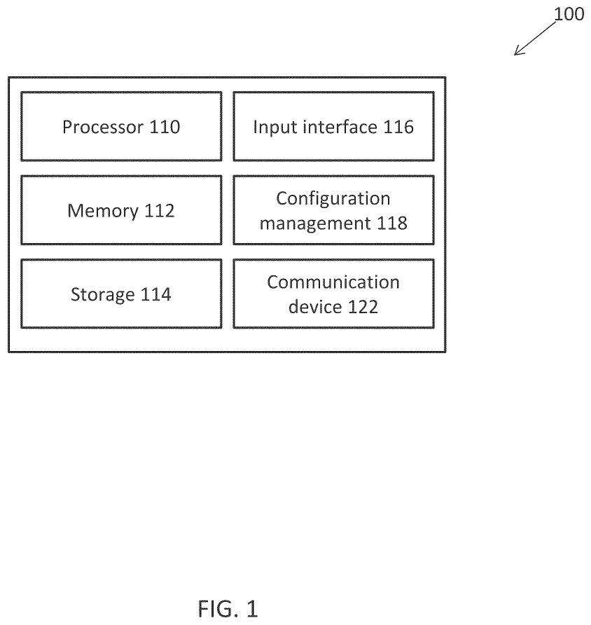

FIG. 1 is a block diagram of an exemplary computing device 100 consistent with some embodiments of the invention. The computing device 100 may include processor 110, such as, for example, a central processing unit (CPU). In some embodiments, the processor 110 may include, or may be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing circuitry such as processor 110 may be coupled to a memory 112.

Memory 112 may contain instructions that when executed by processor 110, may perform the methods described in more detail herein. Memory 112 may be further used as a working scratch pad for processor 110, a temporary storage, and others, as the case may be. Memory 112 may be a volatile memory such as, but not limited to, random access memory (RAM), or non-volatile memory (NVM), such as, but not limited to, flash memory.

Processor 110 may be further connected to a communication module 120, such as a network interface card, for providing connectivity between computing device 100 and a network (not shown). Processor 110 may be further coupled with a storage device 114. Storage device 114 may be used for the purpose of storing data for the purposes as described herein. While illustrated in FIG. 1 as a single device, it is to be understood that storage device 114 may include multiple devices either collocated or distributed.

Processor 110 and/or memory 112 may also include machine-readable media for storing software. “Software” as used herein refers broadly to any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform the various functions described in further detail herein.

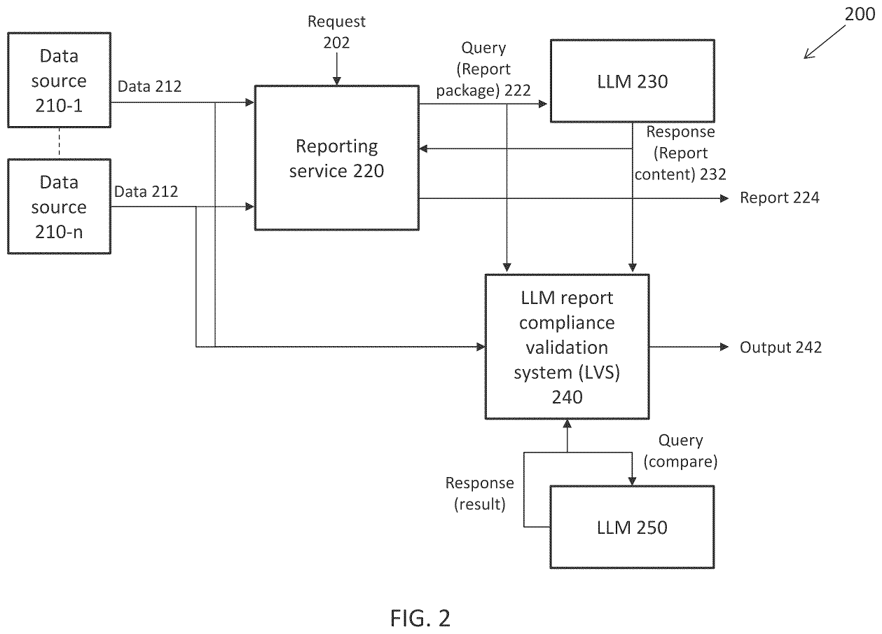

In some embodiments, device 100 may include one or more input interfaces 116. Input interface 116 may be configured to ingest and format data (such as data 212 shown in FIG. 2) for use by device 100. In some embodiments, device 100 may include a configuration management module 118 which may be configured to configure device 100 such as, for example, to optimize the results of and/or provide judgmental qualitative and quantitative measures on the operation of device 100.

In some embodiments, device 100 may include a communication module 120 for enabling the transmission and/or reception of data. Communication module 120 may be used for communicating a notification or output such as output 242 (FIG. 2). Communication module 120 may include human interface components (not shown) such as a display device for displaying information to a user and input devices such as a touch screen and/or a keyboard and a pointing device (e.g., a mouse or a trackball) by which the user can provide input to device 100.

FIG. 2 shows a system 200 for validating report content generated using an LLM consistent with some embodiments of the invention. As shown in FIG. 2, system 200 may be configured to curate reports 224 by a reporting service 220 operating a RAG process and using LLM 230 for report content generation. LLM report validation system (LVS) 240 may be configured to validate the compliance of report content 232 generated by LLM 230. LLM report validation system 240 may call upon a second LLM 250 as part of the compliance validation process.

Reporting service 220, LLM 230, LLM report validation system 240, data sources 210, and LLM 250 may each be computing devices such as computing device 100 defined above and may be implemented on a server, distributed server, virtual server, cloud-based server, and combinations thereof and may make use of cloud and software as a service (SaaS) processing. Reporting service 220 and LLM report validation system 240 may be separate or combined software modules running on a computing device 100. One or more of data sources 210, reporting service 220, LLM 230, LLM report validation system 240, and LLM 250 may operate on a single computing device or may be separate computing devices that may include or may be in communication with a non-transitory computer readable medium (such as memory 112) containing instructions that when executed by at least one processor (such as processor 110) are configured to perform the functions and/or operations necessary to provide the functionality described herein. While system 200 is presented herein with specific components and modules, it should be understood by one skilled in the art, that the architectural configuration of system 200 as shown may be simply one possible configuration and that other configurations with more or fewer or combined components are possible.

Where system 200 or one or more of reporting service 220, LLM 230, LLM report validation system 240, and LLM 250 may be said herein to provide specific functionality or perform actions, it should be understood that the functionality or actions may be performed by a relevant processor such as processor 110 that is part of one or each of reporting service 220, LLM 230, LLM report validation system 240, and LLM 250, that may call on other components of system 200 and memory such as memory 112 that may include instructions which, when executed by processor 110 may cause the execution of a method or process described herein. In non-limiting examples, reporting service 220 may instruct data source 210 to provide analytical data or infographics, or reporting service 220 may instruct LLM report validation system 240 to validate report content 232. In some embodiments, system 200, and the components thereof may be controlled by a processor 110 and related memory 112 that is part of an overall system controller (not shown).

In some embodiments, the components of system 200 may be in data communication via a communications network (not shown). This communications network may include a wide variety of network configurations and protocols that facilitate the intercommunication of the computing devices such as reporting service 220, LLM 230, LLM report validation system 240, and/or LLM 250.

As above, LLMs 230 and 250 are AI programs trained on huge sets of data that may recognize and generate text, among other tasks. In some embodiments, reporting service 220 and or data sources 210 may be in data communication with LLM 230 using an API provided by LLM 230. In some embodiments, LLM report validation system (LVS) 240 may be in data communication with LLM 250 using an API provided by LLM 250.

In system 200, following a request 202 (such as from a user) for a financial report 224, reporting service 220 may retrieve relevant source financial metrics 212 for report 224 from data sources 210-1 . . . 210-n such as by requesting source financial metrics including raw data as well as financial analyses and/or infographics.

Reporting service 220 may query LLM 230 with a query (report package) 222 including source financial metrics 212 in a format suitable for use by LLM 230 and prompts (one or more queries) engineered for understanding by LLM 230 to generate report content 232. A response from LLM 230 in the form of response (report content) 232, which may be provided in multiple parts, may be returned to reporting service 220 for collation and formatting into an output report 224. In some embodiments, report package 222 or parts thereof may be provided in a JSON file.

In a non-limiting example, a user may request 202 a commentary report 224 on a client's financial portfolio. Reporting service 220 may retrieve relevant source financial metrics 212 such as the client's portfolio composition, latest market prices, infographics, and so forth, such as by requesting such data from data sources 210-1 . . . 210-n. Reporting service 220 may query LLM 230 with a query (report package) 222 including an LLM friendly version of the source financial metrics about the portfolio's risk, return, etc. with prompts (queries) including query language that will sufficiently guide LLM 230 to generate report content 232 based on report package 222. As a response from LLM 230, generated response (report content) 232 may be returned to reporting service 220 for collation and formatting into an output report 224 according to the original request.

Financial metrics 212 may be of any suitable structure and format and the volume and span (number of parameters) of financial metrics 212 may be theoretically unlimited. In some embodiments, varying types and numbers of data sources 212 (shown in FIG. 2 as data source 210-1 . . . 210-n) may provide source financial metrics 212. Non-limiting examples of data sources 210 may include financial networks, financial data warehouses, data warehouses, and so forth. Financial metrics 212 provided by data sources 210 may include but is not limited to, for example, financial market data, data analyses, infographics, EOD historical data, client financial portfolio data, market indices, related financial market data including ESG (environmental, social, and corporate governance), financial sentiment extracted from news articles, social media sentiment, social media activity, alignment with UN sustainable development goals, online data, streaming data, databases, and/or the like. Financial metrics 212 may include training datasets that may include known examples of financial metrics that have previously caused hallucinations by LLM 110.

In some embodiments, LLM report compliance validation system 240 may be configured to validate report content 232 generated by LLM 230. In some embodiments, LLM report validation system 240 may use LLM 250 to extract financial metrics from within report content 232 and/or within completed report 224, and to compare source financial metrics 212 and/or report package 222 financial metrics with extracted financial metrics that is found by LLM 250. In some embodiments, LLM 250 may be LLM 230. In some embodiments, LLM 250 may be an external LLM service that is not part of LLM report validation system 240.

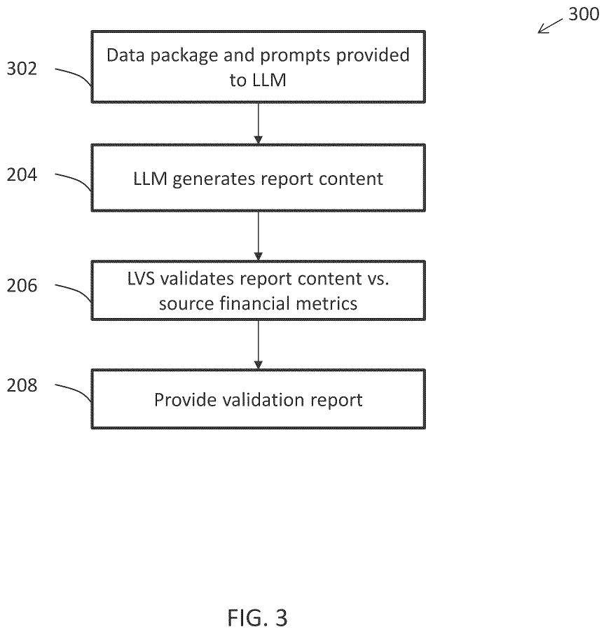

FIG. 3 is a diagram of an example process 300 for validating LLM report content consistent with some embodiments of the invention. Process 300 described below may be implemented in system 200 as described above. A non-transitory computer readable medium may contain instructions that when executed by at least one processor performs the method and operations described at each of the steps in process 300. The non-transitory computer readable medium and at least one processor may correspond to one or more of processor 110 and memory 112 of one or more of the components of system 200. Process 300 may make use of machine learning processes as defined herein.

In step 302, as above, following a request 202 (such as from a user) for a report 224, reporting service 220 may retrieve relevant source financial metrics 212 for report 224 from data sources 210. Using source financial metrics 212, reporting service 220 may query LLM 230 with report package 222. The same source financial metrics 212 (and/or report package 222) provided to LLM 230 is also provided to LVS 240 (for example by reporting service 220 instructing data source 210 to provide source financial metrics 212 to LVS 240, or by reporting service forwarding source financial metrics 212 to LVS 240, or by data source being configured to forward all source financial metrics to LVS 240). In some embodiments, reporting service 220 may determine that request 202 requires multiple queries 222 to LLM 230, with associated collation of the respective responses 232 from LLM 230.

In step 304, in response to query (report package) 222 including appropriate prompts and financial metrics, LLM 230 may generate a response (report content) 232 including text and/or infographics to reporting service 220 as an output to the interpretation by LLM 230 of query 222. The same report content 232 is also provided to LVS 240.

In step 306, LVS 240 may compare the source data 212 (and/or report package 222) with report content 232 (and/or report 224) to validate compliance of all financial metrics in report content 232 as true to source financial metrics 212 and not “made up” (hallucinated). In some embodiments, the validation of report content 232 may be performed by querying LLM 250 (query 252) to compare the source financial metrics 212 and the report content 232 such that LLM 250 may, for example, interpret report content 232 to find financial metrics in related text within report content 232 and then compare these “found financial metrics” with source financial metrics 212, where the response 254 is the result of the comparison. In other words, as queried (252) by LVS 240, LLM 250 may review and interpret the text of report content 232 to find financial metrics that may then be compared by LLM 250 to source financial metrics 212. The query 252 from LVS 240 to LLM 250 may include source financial metrics 212 (or report package 222), report content 232 (or report 224) and prompts engineered to cause LLM 250 to interpret report content 232, perform the desired comparison and return a response (result) 254.

In some embodiments, based on the comparison result 254 of LLM 250, LVS 240 may determine whether the found financial metrics have been used in the correct context (validated) or incorrectly used (non-validated). In a non-limiting example of non-validated financial metrics, source financial metrics 212 may include a first number showing 10% performance and a second number showing 2% risk. Report content 232 describing that the portfolio has increased in value by 2% would indicate a correct numeric value found in the financial metrics, but incorrectly applied to performance instead of risk.

In some embodiments, LVS 240 may assess whether data related text includes financial metrics that was not actually provided as part of source financial metrics 212 based on response 254 from appropriately querying LLM 250. In some embodiments, LVS 240 may assess whether data related text includes financial metrics that has been corrupted, for example a different value has been used that is not found in source financial metrics 212 based on response 254 from appropriately querying LLM 250.

In some embodiments, LVS 240 may evaluate whether the report content 232 breaches any regulatory compliance rules based on response 254 from appropriately querying LLM 250. In some embodiments, LLM validation system 110 may evaluate whether the report content 232 includes any financial advice based on response 254 from appropriately querying LLM 250.

In step 308, output 242 of the analysis of step 206 may be stored such as in storage 114 and/or may be provided via human interface components such as a GUI of Communication module 120. In some embodiments, output 242 may include a score indicating the accuracy of report content 232. In some embodiments, report content 232 may be regenerated such as by repeating step 302.

Following step 304 or 306, reporting service 220 may prepare report 224 (as a response to request 202) by collating one or more report content 232 received from LLM 230 and formatting these in a desired report format.

Unless otherwise defined, all technical and scientific terms used herein have the same meaning as commonly understood by one of ordinary skill in the art. The materials, methods, and examples provided herein are illustrative only and not intended to be limiting.

Various embodiments are described herein with reference to a system, method, device, or computer readable medium. It is intended that the disclosure of one is a disclosure for all. For example, it is to be understood that disclosure of a computer readable medium described herein also constitutes a disclosure of methods implemented by the computer readable medium, and systems and devices for implementing those methods, via for example at least one processor. It is to be understood that this form of disclosure is for each of discussion only, and one or more aspects of one-embodiment herein may be combined with one or more aspects of other embodiments herein, within the intended scope of this disclosure.

Aspects of this disclosure may provide a technical solution to the challenging technical problem of LLM validation and may relate to a system for providing LLM validation with the system having at least one processor (e.g., processor, processing circuit or other processing structure described herein), including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

As used herein the terms “machine learning” or “artificial intelligence” refer to use of algorithms on a computing device that parse data, learn from the data, and then make a determination or generate data, where the determination or generated data is not deterministically replicable (such as with deterministically oriented software as known in the art).

In some embodiments, machine learning algorithms (also referred to as machine learning models or artificial intelligence in the present disclosure) may be trained using training examples, for example in the processes described herein. Some non-limiting examples of such machine learning algorithms may include classification algorithms, data regressions algorithms, image segmentation algorithms, mathematical embedding algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “processor”, “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method for ensuring compliance of financial report content in a retrieval-augmented generation (RAG) process, comprising: retrieving source financial metrics; providing the source financial metrics to a first large language model (LLM) for generating financial report content therewith; extracting, by a second LLM, extracted financial metrics from the financial report content, the extracted financial metrics representing financial data identified within the generated report content; and comparing, by the second LLM, the extracted financial metrics to the source financial metrics to determine whether the first LLM has introduced hallucinated financial metrics into the financial report content.

2. The method of claim 1, further including retrieving the source financial metrics as part of a retrieval-augmented generation process from one or more data sources.

3. The method of claim 1, further including providing the source financial metrics within a report package along with prompts engineered for understanding by the first LLM to generate the financial report content.

4. The method of claim 1, further including providing the source financial metrics, the financial report content, and prompts engineered for understanding by the second LLM to compare the source financial metrics and the financial report content.

5. The method of claim 1, further including providing the source financial metrics as at least one of raw financial data, financial sentiment extracted from news articles, and/or analytical financial data.

6. The method of claim 1, further including defining the hallucinated financial metrics as one of: use of the source financial metrics in an incorrect context, inclusion of metrics not provided in the source financial metrics, or corruption of metrics included in the source financial metrics.

7. The method of claim 1, further including utilizing application programming interfaces for communications between a reporting service and the first and second LLMs.

8. The method of claim 1, further including prompting the second LLM to evaluate whether the financial report content includes financial advice.

9. The method of claim 1, further including prompting the second LLM to evaluate whether the financial report content breaches financial compliance rules.

10. A non-transitory computer-readable medium containing instructions that, when executed by at least one processor, cause the at least one processor to perform operations comprising: retrieving source financial metrics; providing the source financial metrics to a first large language model (LLM) for generating financial report content therewith; extracting, by a second LLM, extracted financial metrics from the financial report content, the extracted financial metrics representing financial data identified within the generated report content; and comparing, by the second LLM, the extracted financial metrics to the source financial metrics to determine whether the first LLM has introduced hallucinated financial metrics into the financial report content.

11. The non-transitory computer-readable medium of claim 10, the operations further including retrieving the source financial metrics as part of a retrieval-augmented generation process from one or more data sources.

12. The non-transitory computer-readable medium of claim 10, the operations further including providing the source financial metrics within a report package along with prompts engineered for understanding by the first LLM to generate the report content.

13. The non-transitory computer-readable medium of claim 10, the operations further including providing the source financial metrics, the financial report content, and prompts engineered for understanding by the second LLM to compare the source financial metrics and the report content.

14. The non-transitory computer-readable medium of claim 10, the operations further including providing the source financial metrics as at least one of raw financial data, financial sentiment extracted from news articles, or analytical financial data.

15. The non-transitory computer-readable medium of claim 10, the operations further including defining the hallucinated financial metrics as one of: use of the source financial metrics in an incorrect context; inclusion of metrics not provided in the source financial metrics; or corruption of metrics included in the source financial metrics.

16. The non-transitory computer-readable medium of claim 10, the operations further including utilizing application programming interfaces for communications between a reporting service and the first and second LLMs.

17. The non-transitory computer-readable medium of claim 10, the operations further including prompting the second LLM to evaluate whether the financial report content includes financial advice.

18. The non-transitory computer-readable medium of claim 10, the operations further including prompting the second LLM to evaluate whether the financial report content breaches financial compliance rules.

19. A system comprising at least one processor and at least one memory storing instructions that, when executed by the at least one processor, cause the system to: retrieve source financial metrics; provide the source financial metrics to a first large language model (LLM) for generating financial report content therewith; extract, by a second LLM, extracted financial metrics from the financial report content, the extracted financial metrics representing financial data identified within the generated report content; and compare, by the second LLM, the extracted financial metrics to the source financial metrics to determine whether the first LLM has introduced hallucinated financial metrics into the financial report content.

20. The system of claim 19, the instructions further including prompting the second LLM to evaluate whether the financial report content includes financial advice or breaches financial compliance rules.
